(19) United States
(12) Patent Application Publication
(10) Pub. No.: US 2004/0066837 A1
(43) Pub. Date: Apr. 8, 2004

(54) Method and apparatus for providing accurate junction temperature in an integrated circuit

(76) Inventors: Joshua W. Armour, Williston, VT (US); Craig Atherton, Colchester, VT (US); Zachary Berndlmaier, North Hero, VT (US); Jeffrey Durochia, Hinesburg, VT (US); Curt Guenther, Essex Junction, VT (US); Kenneth A. Lavallee, Colchester, VT (US); Gerard Salem, Essex Junction, VT (US)

Correspondence Address: IBM MICROELECTRONICS, INTELLECTUAL PROPERTY LAW, 1000 RIVER STREET, 972 E, ESSEX JUNCTION, VT, 05452, US

(21) Appl. No.: 10/264,913

(22) Filed: Oct. 4, 2002

(51) Int. Cl. G01K 7/01

(52) U.S. Cl. 374/178

(57) ABSTRACT

A method and apparatus for providing a more accurate reading of the junction temperature within an Integrated Circuit (IC) where temperature sensing elements are used that are sensitive to process changes. The apparatus stores an offset value in the IC that is used by internal temperature reading circuitry to adjust the temperature read/calculated from the sensing elements to more accurately reflect the actual junction temperature.

### BACKGROUND

1. Technical Field of the Present Invention

The present invention generally relates to integrated circuits, and more particularly, to methods and apparatuses that measure junction temperature in an integrated circuit.

2. Description of Related Art

As used herein, the term junction temperature refers to the temperature at various junctions (e.g. PN junction etc.) within a semiconductor device. The junction temperature is typically calculated by the sum of the environment temperature and a temperature elevation which is due to the Joule heat of the junction. The junction temperature is one of the rated values of a semiconductor device. When the junction temperature exceeds a rated value, an increase in leakage current, lowering of the long-term reliability, or breakdown may take place.

The junction temperature is typically measured in the integrated circuit (IC) via the use of some internal circuitry such as diodes (e.g. Schottky) to serve as the temperature sensing element. Temperature reading and processing circuitry is used to read the voltage values from the sensing elements, and convert the voltage value to a corresponding temperature equivalent value. Unfortunately, the diodes themselves are very sensitive to wafer process changes, and therefore, their quality (ideality) can vary across neighboring IC's upon a wafer. This sensitivity results in the temperature reading and processing circuitry providing a temperature value that is inaccurate.

It would, therefore, be a distinct advantage to have a method and apparatus for accurately determining the junction temperature within an integrated circuit. The present invention provides such a method and apparatus.

### SUMMARY OF THE PRESENT INVENTION

The present invention provides a more accurate reading of the junction temperature within an Integrated Circuit (IC) where temperature sensing elements are used that are sensitive to process changes. The present invention stores an offset value in the IC that is used by internal or external temperature reading circuitry to adjust the temperature read/calculated from the sensing elements to more accurately reflect the actual junction temperature.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a schematic diagram of an integrated circuit illustrating a preferred embodiment of the present invention;

FIG. 2 is a flow chart illustrating the steps for creating the offset value stored in the integrated circuit of FIG. 1 according to the teachings of the present invention; and

FIG. 3 is a chart 300 illustrating how the offset slope of FIG. 2 is calculated according to the teachings of the present invention.

### DETAILED DESCRIPTION OF THE PREFERRED EMBODIMENT OF THE PRESENT INVENTION

In the following description, well-known circuits have been shown in block diagram form in order not to obscure the present invention in unnecessary detail. For the most part, details concerning timing considerations and the like have been omitted inasmuch as such details are not necessary to obtain a complete understanding of the present invention, and are within the skills of persons of ordinary skill in the relevant art.

The accurate portrayal of the junction temperature within an integrated circuit is critical for many designers who integrate and use the IC within an actual product. Without an accurate picture of the junction temperature, the overheating of the IC can occur resulting in various types of damage to the IC and surrounding components. The present invention realizes that most temperature sensing elements within the IC are process sensitive, and therefore, inherently inaccurate across neighboring IC's upon a wafer. To resolve the process problem, the present invention stores an offset value corresponding to the inaccuracy of the temperature sensing element so that an accurate value is obtained when this offset value is added or otherwise used to correct the value provided by the sensing element.

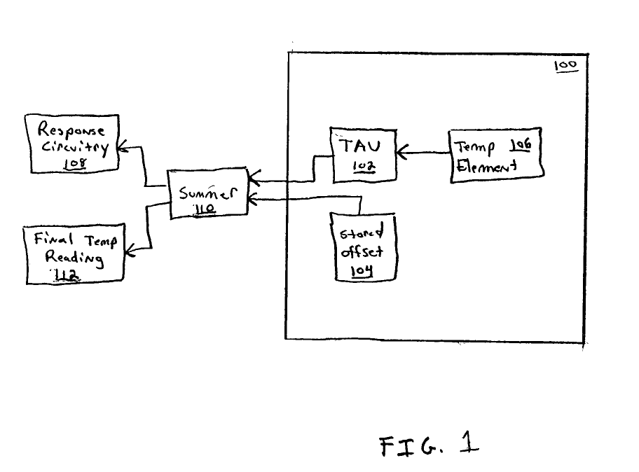

Reference now being made to FIG. 1, a schematic diagram of an integrated circuit 100 is shown illustrating a preferred embodiment of the present invention. More specifically, the integrated circuit includes a junction temperature sensing element(s) 106, a location for storing the offset value (Stored Offset) 104, and Thermal Assist Unit (TAU) 102. External to the IC 100 are Response Circuitry 108, Final Temp Reading Circuitry 112, and Summer 110.

In the preferred embodiment of the present invention, the temperature sensing elements 106 are diodes. The Stored Offset 104 stores a logical value for correcting the processing sensitivity of the sensing elements 106. Stored Offset 104 can be of any type of memory or similar circuitry for retaining logical values after power has been turned off to the IC 100 (e.g. fuses). The TAU 102 reads the voltage values provided by the Temp element 106, and converts these values to a corresponding temperature value. This temperature value is then provided to Summer 110. Summer 110 sums or otherwise corrects the temperature value with the offset value, and provides the corrected temperature value to the Final Temp Circuitry 112 and Response Circuitry 108.

The Response Circuitry 108 can use the corrected temperature value to take some predetermined action within the IC 100 to help resolve any temperature overheating problems (e.g. Powering down non-critical portions of the IC). Final Temp Reading Circuitry 112 performs any other required processing of the corrected temperature reading. Although, the Response Circuitry 112 has been illustrated as residing outside the IC 100, it can also be incorporated within the IC 100 to serve the same or similar function.

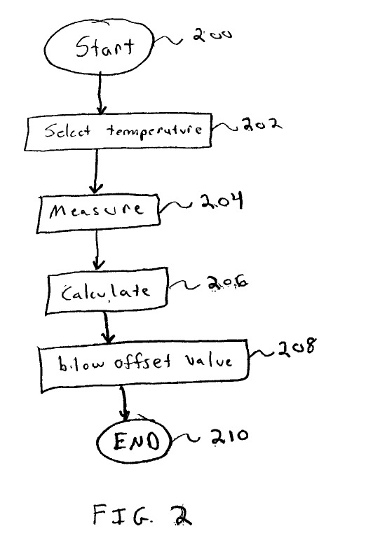

Reference now being made to FIG. 2, a flow chart is illustrated for showing the steps for creating the offset value stored in the Stored Offset 104 according to the teachings of the present invention. Specifically, the method begins at step 200 at wafer final test, or other suitable testing stage, where a temperature is selected (step 202) for calibrating the TAU. In the preferred embodiment of the present invention, the temperature is ambient temperature. The method proceeds to step 204 where the temperature value provided by the TAU 102 is read.

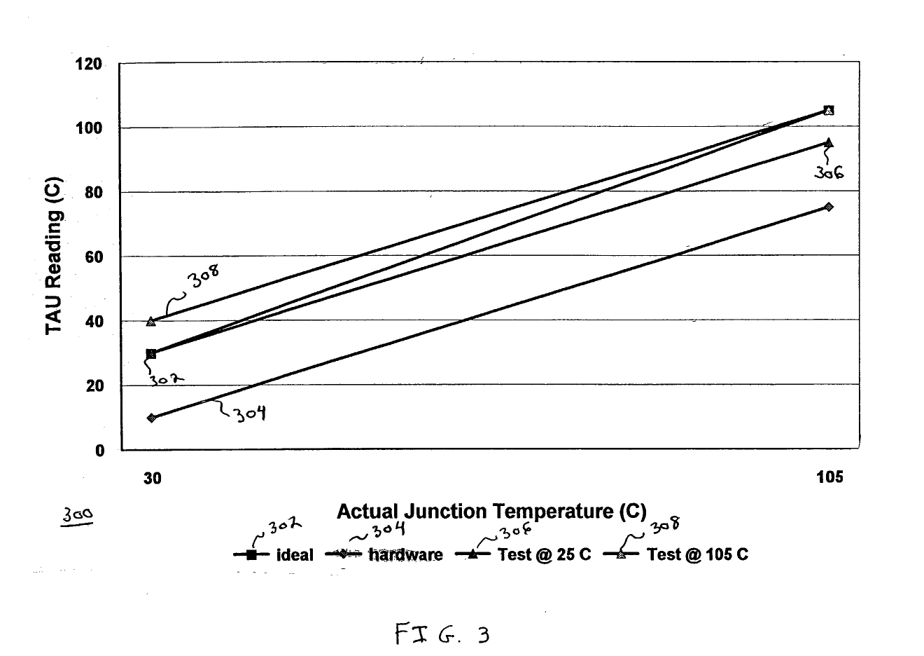

The method then proceeds to step 206 where the offset value is calculated. The offset value is calculated by using a predetermined formula for offset slope. The predetermined formula is created by measuring representative hardware at both ambient and some elevated level(s). Realizing that the measured temperatures will always be linear in nature, these readings are used to calculate the offset slope for all other similar hardware as explained in connection with FIG. 3 below.

Reference now being made to FIG. 3, a chart 300 is shown illustrating how the offset slope is calculated according to the teachings of the present invention. The chart 300 represents the temperature readings in Celsius as provided by the TAU 102 on the y-axis and the actual junction temperature in Celsius on the x-axis. It should be noted that when comparing these one to another in this fashion, the relevant data points become linear in nature.

Line 302 represents ideal readings (assumption of no error or offset) for the Tau vs. Actual junction temperature. Line 306 represents the reading of the junction temperature at ambient temperature (˜25 degrees C.), comparing this value to the value provided by the Tau at this temperature, and adjusting the Tau to reflect the actual junction temperature at ambient, and using this adjustment for all further readings to 105 degrees C. Line 308 illustrates the reading of the junction temperature at 105 degrees C., comparing the junction temperature to the value provided by the Tau, adjusting the Tau value to reflect the junction temperature read at 105 degrees C., and using this adjustment for all future Tau readings to ambient 25 degrees C. It should be noted that neither lines 304 nor 308 follow the ideal line 302 for junction temperature.

By varying the operating temperature of the hardware and comparing the readings provided by the Tau to the actual junction temperature for numerous pieces of hardware, a line 304 can be plotted that is characteristic of the actual junction temperature for the various ICs having this type of hardware. The formula Y=MX+B where Y=Tau, M=slope, X=actual temperature reading, and B=y intercept can be used for the line 304 to extract the slope M. The present invention uses the slope value calculated during the characterization of the hardware for line 304 to adjust the value provided by the Tau, for all ICs, to more accurately show the actual junction temperature for all future readings.

Referring now back to FIG. 2, the method continues by storing this offset value into the Stored Offset 104. Thereafter, the method ends at step 210.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. An integrated circuit comprising:
sensing circuitry for sensing the temperature of the junctions within the integrated circuit; and
offset circuitry for providing an offset value that modifies the sensed temperature to more accurately reflect the actual temperature of the junctions.

2. The integrated circuit of claim 1 wherein the sensing circuitry senses different temperature values depending upon the particular manufacturing process used to create the integrated circuit.

3. The integrated circuit of claim 2 wherein the sensing circuitry includes a pair of diodes.

4. The integrated circuit of claim 3 wherein the sensing circuitry includes:
measuring circuitry for measuring the voltage differential between the pair of diodes, the voltage differential corresponding to the temperature generated by the junctions within the integrated circuit.

5. A method of measuring the junction temperature in an integrated circuit, the method comprising the steps of:
sensing the junction temperature from circuitry residing within the integrated circuit; and
modifying the sensed temperature to more accurately reflect the actual junction temperature of the integrated circuit.

6. The method of claim 5 wherein the step of modifying includes the steps of:
storing an offset value in the integrated circuit; and
modifying the sensed temperature with the stored offset value to more accurately reflect the actual junction temperature of the integrated circuit.

7. The method of claim 6 wherein the step of sensing includes the steps of:
sensing the voltage differential between a pair of diodes; and
converting the sensed voltage differential to a corresponding temperature value.

8. The method of claim 7 wherein the step of storing includes the steps of:
sensing the junction temperature at a first temperature;
sensing the junction temperature at a second temperature;
calculating an offset value representing a slope of the first and second temperatures versus the actual junction temperatures.

9. The method of claim 6 wherein the step of storing includes the steps of:
sensing the junction temperature at a first temperature;
sensing the junction temperature at a second temperature;
calculating an offset value representing a slope of the first and second temperatures versus the actual junction temperatures.

10. The method of claim 8 wherein the step of sensing includes the steps of:
sensing the voltage differential between a pair of diodes; and
converting the sensed voltage differential to a corresponding temperature value.

11. An apparatus for measuring the junction temperature in an integrated circuit, the apparatus comprising:
means for sensing the junction temperature from circuitry residing within the integrated circuit; and
means for modifying the sensed temperature to more accurately reflect the actual junction temperature of the integrated circuit.

12. The apparatus of claim 11 wherein the means for modifying includes:
means for storing an offset value in the integrated circuit; and
means for modifying the sensed temperature with the stored offset value to more accurately reflect the actual junction temperature of the integrated circuit.

13. The apparatus of claim 12 wherein the means for sensing includes:
means for sensing the voltage differential between a pair of diodes; and
means for converting the sensed voltage differential to a corresponding temperature value.

14. The apparatus of claim 13 wherein the means for storing includes:
means for sensing the junction temperature at a first temperature;
means for sensing the junction temperature at a second temperature;
means for calculating an offset value representing a slope of the first and second temperatures versus the actual junction temperatures.

15. The apparatus of claim 12 wherein the means for storing includes:
means for sensing the junction temperature at a first temperature;
means for sensing the junction temperature at a second temperature;
means for calculating an offset value representing a slope of the first and second temperatures versus the actual junction temperatures.

16. The apparatus of claim 15 wherein the means for sensing includes:
means for sensing the voltage differential between a pair of diodes; and
means for converting the sensed voltage differential to a corresponding temperature value.
